(19) United States
(12) Patent Application Publication
(10) Pub. No.: US 2016/0328149 A1
(43) Pub. Date: Nov. 10, 2016

(54) DISPLAY SCREEN-BASED PHYSICAL BUTTON SIMULATION METHOD AND ELECTRONIC DEVICE

(71) Applicants: Le Holdings (Beijing) Co., Ltd., Beijing (CN); Lemobile Information Technology (Beijing) Co., Ltd., Beijing (CN)

(72) Inventor: Jian Liu, Beijing (CN)

(21) Appl. No.: 15/101,628

(22) PCT Filed: Dec. 3, 2014
(86) PCT No.: PCT/CN2014/092953

§ 371 Date: Jul. 18, 2016

(30) Foreign Application Priority Data
Dec. 18, 2013 (CN) 201310724245.4

(51) Int. Cl. G06F 3/0488; G06F 3/0489; G06F 3/0482; G06F 3/0484

(52) U.S. Cl. CPC G06F 3/04886; G06F 3/04847; G06F 3/04897; G06F 3/0482

(57) ABSTRACT

A display screen-based physical button simulation method and electronic device, relating to the field of multimedia, and able to control the electronic device when the electronic device is not switched on and when physical buttons are not being used. The method is: after the electronic device is connected to a power source, at least one virtual button is displayed on the display screen of the electronic device; wherein, corresponding functions are pre-set to each of the at least one virtual buttons; on the basis of the user operating a first virtual button amongst the at least one virtual buttons, an operating command corresponding to the first virtual button is generated; the first virtual button is any one of the at least one virtual buttons; finally, on the basis of the operating command, the operation corresponding to the function corresponding to the first virtual button is executed on the electronic device. The present embodiment of the invention is used for simulating physical buttons.

### FIELD OF THE INVENTION

The present application relates to the technical field of multimedia and in particular relates to a method for simulating mechanical keys on display screen and an electronic device.

### BACKGROUND OF THE INVENTION

Mechanical key, which are keys with mechanical structure, are often arranged in existing electronic devices such as televisions, computers, cell phones and tablet computers, and thus will be worn down in use, especially keys used relatively frequently, such as power key, volume key and camera key. If being used frequently for some time, mechanical keys may have a poor contact problem due to being worn down, to thereby affect on users and the appearance of the electronic devices. Additionally, there are gaps generally around the physical button in which dust is easy to accumulate and difficult to clean.

In the prior art, to solve the above problems, a touch panel with touch function, on which a number of keys are arranged, is set in an electronic device generally. However, the touch panel described above can only operate after the electronic device starts up; hence, mechanical keys set in the electronic device are still required.

### SUMMARY OF THE INVENTION

Embodiments of the present application provide a method for simulating mechanical keys on display screen and an electronic device, to thereby operate the electronic device without mechanical keys.

In order to achieve the above purpose, the embodiments of the present application adopt the following technical solutions:

In a first aspect, an embodiment of the present disclosure provides a method for simulating mechanical keys on display screen, including:

displaying at least one virtual key on display screen of an electronic device upon the electronic device connecting with a power source, wherein corresponding functions are pre-set to each of the at least one virtual key;

generating operation command corresponding to a first virtual key of the at least one virtual key according to a user operation on the first virtual key, wherein the first virtual key is any one of the at least one virtual key; and

executing an operation corresponding to the corresponding function pre-set to the first virtual key in the electronic device according to the operation command.

In a second aspect, an embodiment of the present disclosure provides an electronic device, including:

a key display unit, configured to display at least one virtual key on display screen of the electronic device upon the electronic device connecting with a power source, wherein corresponding functions are pre-set to each of the at least one virtual key;

an operation identification unit, configured to generate operation command corresponding to a first virtual key of the at least one virtual key according to a user operation on the first virtual key, wherein the first virtual key is any one of the at least one virtual key; and

a control unit, configured to execute an operation corresponding to the corresponding function pre-set to the first virtual key in the electronic device according to the operation command.

With the method for simulating mechanical keys on display screen and the electronic device according to embodiments of the application, at least one virtual key is displayed on display screen of an electronic device upon the electronic device connecting with a power source, wherein corresponding functions are pre-set to each of the at least one virtual key, and then operation command corresponding to a first virtual key of the at least one virtual key is generated according to a user operation on the first virtual key, wherein the first virtual key is any one of the at least one virtual key, finally an operation corresponding to the corresponding function pre-set to the first virtual key is executed in the electronic device according to the operation command, wherein the virtual keys include at least one of power key, home key, setting key, volume key and signal source key. in this way, the electronic device can be operated even through without mechanical keys before starting up.

### BRIEF DESCRIPTION OF THE DRAWINGS

In order to describe more clearly the technical solutions according to the embodiments of the present disclosure or in the prior art, the drawings to which reference is made in the description of the embodiments or the prior art will be described below briefly, and evidently the drawings described below are merely illustrative of some of the embodiments of the present disclosure, and those ordinarily skilled in the art can further derive other drawings from these drawings without any inventive effort. In the drawings:

FIG. 1 is a schematic flow diagram of a method for simulating mechanical keys on display screen according to an embodiment of the present application.

FIG. 2 is a schematic flow diagram of another method for simulating mechanical keys on display screen according to an embodiment of the present application.

FIG. 3 is a schematic diagram of a display effect of virtual keys according to an embodiment of the present application;

FIG. 4 is a structural schematic diagram of an electronic device according to an embodiment of the present application.

FIG. 5 is a structural schematic diagram of another electronic device according to an embodiment of the present application.

### DETAILED DESCRIPTION OF THE EMBODIMENTS

The technical solutions according to the embodiments of the present disclosure will be described below clearly and fully with reference to the drawings in the embodiments of the present disclosure, and apparently the embodiments described below are only a part but not all of the embodiments of the present disclosure. All the other embodiments which can occur to those ordinarily skilled in the art based upon the embodiments here in the present disclosure without any inventive effort shall fall into the clamed scope of the present disclosure.

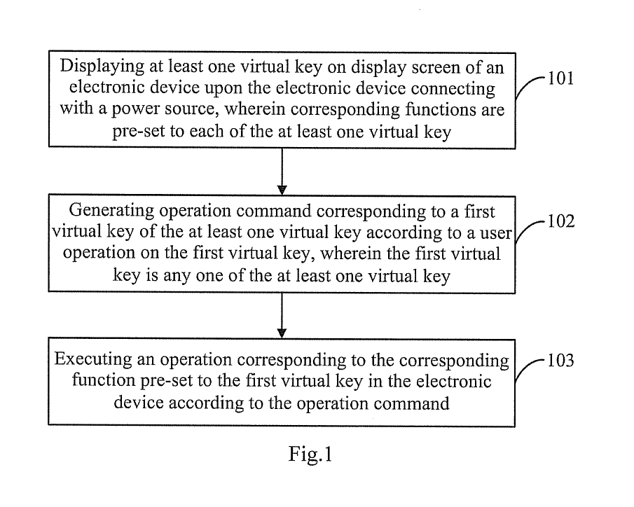

An embodiment of the present application provides a method for simulating mechanical keys on display screen, as shown in FIG. 1, including:

101, displaying at least one virtual key on display screen of an electronic device upon the electronic device connecting with a power source, wherein corresponding functions are pre-set to each of the at least one virtual key;

102, generating operation command corresponding to a first virtual key of the at least one virtual key according to a user operation on the first virtual key, wherein the first virtual key is any one of the at least one virtual key; and

103, executing an operation corresponding to the corresponding function pre-set to the first virtual key in the electronic device according to the operation command.

With the method for simulating mechanical keys on display screen according to embodiments of the application, at least one virtual key is displayed on display screen of an electronic device upon the electronic device connecting with a power source, wherein corresponding functions are pre-set to each of the at least one virtual key, and then operation command corresponding to a first virtual key of the at least one virtual key is generated according to a user operation on the first virtual key, wherein the first virtual key is any one of the at least one virtual key, finally an operation corresponding to the corresponding function pre-set to the first virtual key is executed in the electronic device according to the operation command, to thereby to operate the electronic device even through without mechanical keys before starting up.

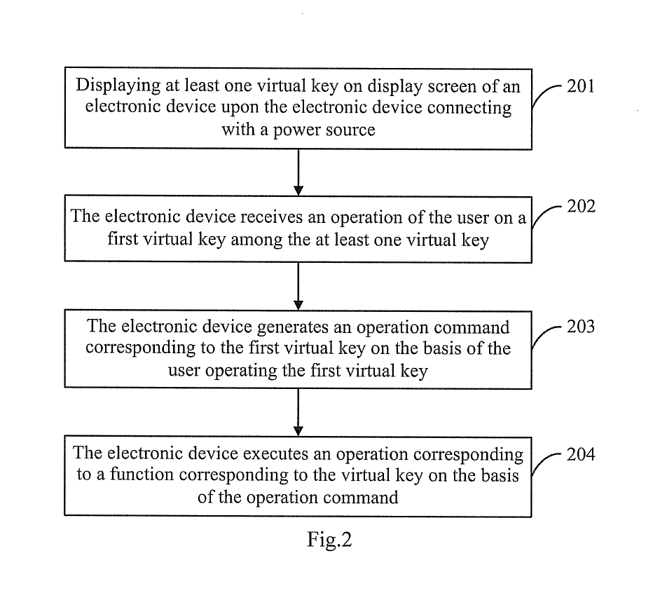

In order to enable those skilled in the art to more clearly understand the technical solutions provided by the embodiments of the present application, another method for simulating mechanical keys on display screen provided by an embodiment of the present application will be described in detail with specific embodiments; as shown in FIG. 2, the method includes:

201, displaying at least one virtual key on display screen of an electronic device upon the electronic device connecting with a power source.

Specifically, after the electronic device is connected to a power source, a power indicator lamp lightens to indicate that the electronic device has been connected to the power source, but is still in an off state; at this moment, power can be supplied to the display screen of the electronic device to lighten the display screen and enable the display screen to display at least one pre-set virtual key, wherein each virtual key is pre-set with one corresponding function which can be realized as long as corresponding virtual buttons are selected for operations.

Additionally and exemplarily, before a device starts up, the display screen of the electronic device can be supplied power by providing an independent dedicated power source to supply power to the display screen in the electronic device or by arranging a power management unit in the electronic device which can control a power source to supply power to the display screen after the electronic device is connected to the power source. Meanwhile, in order to identify the operations of a user on the virtual keys on the display screen before starting up, the independent power source or the power management unit further needs to supply power to an automatic control unit in the electronic device so that the automatic control unit can control the electronic device correspondingly after the user operates the virtual keys. The automatic control unit can be a programmable logic controller, and it can be either an original processor or a management chip of the electronic device or a control unit used specially before starting up arranged in the electronic device, which is not specifically limited herein.

202, the electronic device receives an operation of the user on a first virtual key among the at least one virtual key. The first virtual key can be any one of the at least one virtual key displayed on the display screen.

Exemplarily, different modes can be adopted according to the types of the display screens, so 202 may include:

if the display screen is a touch screen, the user can directly click the first virtual key on the display screen, and after clicking, the display screen is triggered to generate a touch signal according to the user clicking the first virtual key, then the electronic device can determine the virtual key selected by the user as the first virtual key according to the touch signal.

Or, if the display screen is a non-touch screen, the user cannot directly click the virtual keys displayed on the display screen and somatosensory identification can be carried out through a camera on the electronic device. For example, when a user points to the first virtual button with a gesture, the camera can generate a selection signal to the electronic device and the electronic device can determine the virtual key selected by the user as the first virtual key according to the selection signal. In the case, the electronic device further needs to control the power source to supply power to the camera by using a power supply method with reference to the method of 201, and a repeated description thereof will be omitted here.

Or, if the display screen is the non-touch screen and the electronic device is provided with no camera or does not support somatosensory identification, the user can further select the first virtual key through a remote controller, and when the electronic device receives a selection command generated by selecting the first virtual key through the remote controller, the electronic device can determine the virtual key selected by the user as the first virtual key.

203, the electronic device generates an operation command corresponding to the first virtual key on the basis of the user operating the first virtual key.

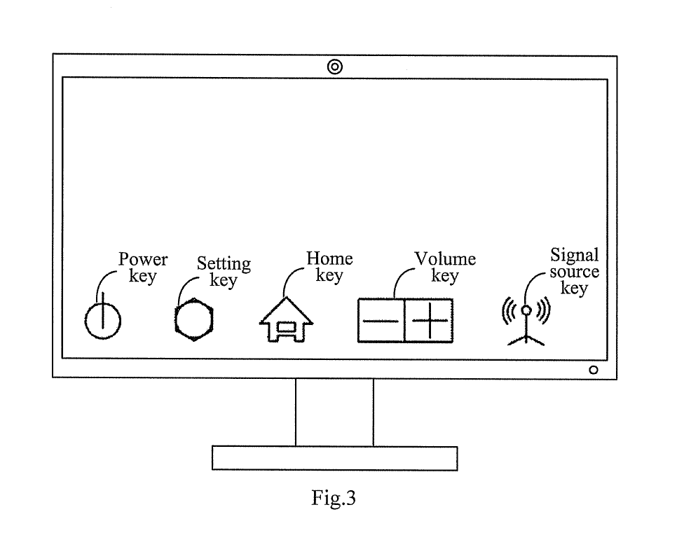

Exemplarily, the virtual keys displayed on the display screen are shown in FIG. 3, and include a power key, a home key, a setting key, a volume key, a signal source key and the like.

Correspondingly, when the first virtual key selected by the user is different, a different operation command is generated, which including:

if the first virtual key selected by the user is a power key, the generated operation command is a command of starting up;

if the first virtual key selected by the user is a home key, the generated operation command is a command of starting up and displaying the homepage;

if the first virtual key selected by the user is a setting key, the generated operation command is a command of starting up and displaying a setting page;

if the first virtual key selected by the user is a volume key, the generated operation command is a command of adjusting volume;

if the first virtual key selected by the user is a signal source key, the generated operation command is a command of selecting signal source.

204, the electronic device executes an operation corresponding to a function corresponding to the virtual key on the basis of the operation command.

Exemplarily, if the operating command is the command of starting up, the power source is controlled to supply power to the electronic device so that the electronic device starts up;

if the operating command is the command of starting up and displaying the homepage, the power source is controlled to supply power to the electronic device so that the electronic device starts up and displays the homepage on the display screen after starting up;

if the operating command is the command of starting up and displaying the setting page, the power source is controlled to supply power to the electronic device so that the electronic device starts up and displays the setting page on the display screen after starting up;

if the operating command is the command of adjusting volume, a volume output by the loudspeaker in the electronic device is adjusted so that the electronic device outputs sound according to the adjusted output volume after starting up;

if the operating command is the command of selecting signal source, a signal source is selected so that the electronic device obtains signals from the selected signal source after starting up.

In comparison to the prior art, according to the method for simulating mechanical keys on display screen provided by the embodiments of the present application, at least one virtual key is displayed on display screen of an electronic device upon the electronic device connecting with a power source, wherein corresponding functions are pre-set to each of the at least one virtual key, and then operation command corresponding to a first virtual key of the at least one virtual key is generated according to a user operation on the first virtual key, wherein the first virtual key is any one of the at least one virtual key, finally an operation corresponding to the corresponding function pre-set to the first virtual key is executed in the electronic device according to the operation command, to thereby to operate the electronic device even through without mechanical keys before starting up, wherein the virtual keys include at least one of power key, home key, setting key, volume key and signal source key.

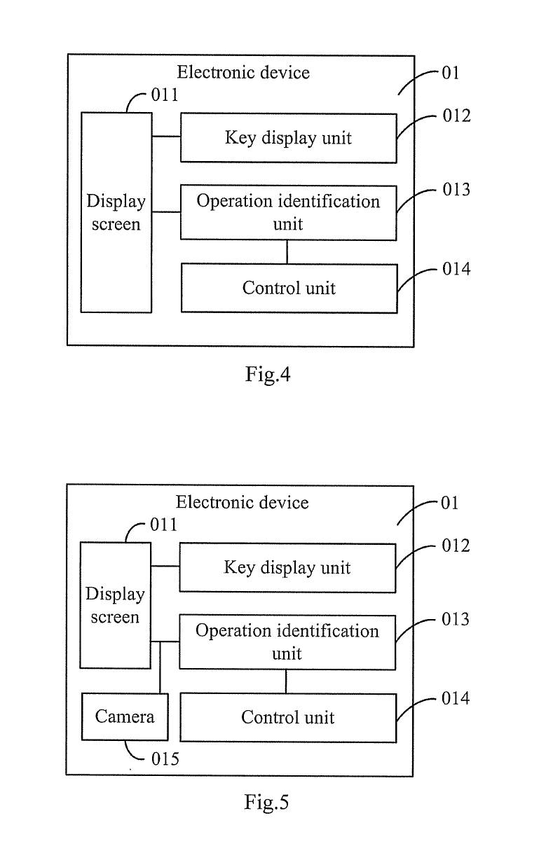

an electronic device 01 according to the embodiment of the present application is shown in FIG. 4, and the electronic device 01 includes a display screen 011, and further includes:

a key display unit 012, configured to display at least one virtual key on display screen of the electronic device upon the electronic device connecting with a power source, wherein corresponding functions are pre-set to each of the at least one virtual key;

an operation identification unit 013, configured to generate operation command corresponding to a first virtual key of the at least one virtual key according to a user operation on the first virtual key, wherein the first virtual key is any one of the at least one virtual key; and

a control unit 014, configured to execute an operation corresponding to the corresponding function pre-set to the first virtual key in the electronic device according to the operation command.

Optionally, if the display screen 011 is a touch screen, the operation identification unit 013 can be configured to:

obtaining a touch signal generated by the display screen 011 which is triggered by clicking the first virtual key by a user;

determine the virtual key selected by the user as the first virtual key according to the touch signal; and

generate the operation command corresponding to the first virtual key.

Optionally, as shown in FIG. 5, if the display screen 011 is a non-touch screen, the electronic device 01 may further include a camera 015; the operation identification unit 013 can be configured to:

determine the virtual key selected by the user via somatosensory identification through the camera 015 as the first virtual key when a user points to a virtual key with a gesture; and

generate the operation command corresponding to the first virtual key; or

receive a selection command generated by selecting a virtual key by the user through a remote controller;

determine the virtual key selected by the user as the first virtual key according to the selection command; and

generate the operation command corresponding to the first virtual key.

Optionally, the virtual buttons include at least one of power key, home key, setting key, volume key and signal source key, the operation identification unit 013 can be configured to:

generate a command of starting up if the first virtual key is a power key;

generate a command of starting up and displaying the homepage if the first virtual key is a home key;

generate a command of starting up and displaying a setting page if the first virtual key is a setting key;

generate a command of adjusting volume if the first virtual key is a volume key;

generate a command of selecting signal source if the first virtual key is a signal source key.

Optionally, the control unit 014 can be configured to:

control the power source to supply power to the electronic device so that the electronic device starts up if the operating command is the command of starting up;

control the power source to supply power to the electronic device so that the electronic device starts up and displays the homepage on the display screen after starting up if the operating command is the command of starting up and displaying the homepage;

control the power source to supply power to the electronic device so that the electronic device starts up and displays the setting page on the display screen after starting up if the operating command is the command of starting up and displaying the setting page;

adjust volume output by the loudspeaker in the electronic device so that the electronic device outputs sound according to the adjusted output volume after starting up if the operating command is the command of adjusting volume;

select a signal source so that the electronic device obtains signals from the selected signal source after starting up if the operating command is the command of selecting signal source

According to the electronic device provided by the embodiments of the application, at least one virtual key is displayed on display screen of an electronic device upon the electronic device connecting with a power source, wherein corresponding functions are pre-set to each of the at least one virtual key, and then operation command corresponding to a first virtual key of the at least one virtual key is generated according to a user operation on the first virtual key, wherein the first virtual key is any one of the at least one virtual key, finally an operation corresponding to the corresponding function pre-set to the first virtual key is executed in the electronic device according to the operation command, to thereby to operate the electronic device even through without mechanical keys before starting up, wherein the virtual keys include at least one of power key, home key, setting key, volume key and signal source key.

With the forgoing descriptions of the embodiments, those skilled in the art can clearly understand the technical solution of the application. For the sake of convenience and conciseness of descriptions, the divisions of the above functional modules are used as examples for explanations; in practical application, functions can be allocated to different functional modules for accomplishment according to requirements; that is to say, the internal structure of the device is divided into different functional modules to accomplish all or part of the functions described above. For the specific working processes of the system, the device and the units described above, reference may be made to corresponding processes in the embodiments of the methods, and a repeated description thereof will be omitted here.

In several embodiments provided by the present application, it should be understood that the disclosed method and device can be implemented in other ways. For example, the device embodiments described above are merely exemplary; for example, the division of the modules or the units is merely a logic function division, and other division manners can be adopted in actual implementation; for instance, a plurality of units or assemblies can be combined or integrated to another system; or some features can be neglected or not executed. On the other hand, mutual coupling, direct coupling or communication connection displayed or discussed can be indirect coupling or communication connection between the devices or the units through some interfaces, which can be in electrical, mechanical or other form.

The units described as separate parts can be or not physically separated; parts displayed as units can be or not physical units, which can be located in the same place or distributed to a plurality of network units. Part or all of the units can be selected according to actual requirements to achieve the object of the solutions of the embodiments.

Additionally, various functional units in each embodiment of the present application can be integrated in one processing unit or exist independently and physically as various units; or, two or more than two units are integrated in one unit. The integrated units can be implemented in the form of hardware or software functional units.

If the integrated units are implemented in the form of the software functional units and sold or used as independent products, they can be stored in a computer-readable storage medium. Based on such understanding, the technical solutions of the present application substantially, or one part thereof contributing to the prior art, or all or part of technical solutions can be embodied in the form of software products; the computer software product is stored in a storage medium, including a plurality of instructions for enabling a computer device (a PC, a server, a network device or the like) or a processor to execute all or part of the steps of the method of each embodiment of the present application. However, the storage medium described above includes various media capable of storing program codes, such as a USB flash disk, a mobile hard disk, a read-only memory (ROM), a random access memory (RAM), a magnetic disk or an optical disk.

1. A method for simulating mechanical keys on display screen, comprising:
displaying at least one virtual key on display screen of an electronic device upon the electronic device connecting with a power source, wherein corresponding functions are pre-set to each of the at least one virtual key;
generating operation command corresponding to a first virtual key of the at least one virtual key according to a user operation on the first virtual key, wherein the first virtual key is any one of the at least one virtual key; and
executing an operation corresponding to the corresponding function pre-set to the first virtual key in the electronic device according to the operation command.

2. The method according to claim 1, wherein if the display screen is a touch screen, generating operation command corresponding to a first virtual key of the at least one virtual key according to a user operation on the first virtual key comprises:
obtaining a touch signal generated by the display screen which is triggered by clicking the first virtual key by a user;
determining the virtual key selected by the user as the first virtual key according to the touch signal; and
generating the operation command corresponding to the first virtual key.

3. The method according to claim 1, wherein if the display screen is a non-touch screen, generating operation command corresponding to a first virtual key of the at least one virtual key according to a user operation on the first virtual key comprises:
determining the virtual key selected by the user via somatosensory identification through a camera as the first virtual key when a user points to the first virtual key with a gesture; and
generating the operation command corresponding to the first virtual key; or receiving a selection command generated by selecting the first virtual key by the user through a remote controller;
determining the virtual key selected by the user as the first virtual key according to the selection command; and
generating the operation command corresponding to the first virtual key.

4. The method according to any one of claims 1-3, wherein the virtual keys comprise at least one of power key, home key, setting key, volume key and signal source key;
generating the operation command corresponding to the first virtual key comprises:
if the first virtual key is a power key, generating a command of starting up;
if the first virtual key is a home key, generating a command of starting up and displaying the homepage;
if the first virtual key is a setting key, generating a command of starting up and displaying a setting page;
if the first virtual key is a volume key, generating a command of adjusting volume;
if the first virtual key is a signal source key, generating a command of selecting signal source.

5. The method according to claim 4, wherein executing an operation corresponding to the corresponding function pre-set to the first virtual key in the electronic device according to the operation command comprises:
if the operating command is the command of starting up, controlling the power source to supply power to the electronic device so that the electronic device starts up;
if the operating command is the command of starting up and displaying the homepage, controlling the power source to supply power to the electronic device so that the electronic device starts up and displays the homepage on the display screen after starting up;
if the operating command is the command of starting up and displaying the setting page, controlling the power source to supply power to the electronic device so that the electronic device starts up and displays the setting page on the display screen after starting up;
if the operating command is the command of adjusting volume, adjusting volume output by the loudspeaker in the electronic device so that the electronic device outputs sound according to the adjusted output volume after starting up;
if the operating command is the command of selecting signal source, selecting a signal source so that the electronic device obtains signals from the selected signal source after starting up.

6. An electronic device, comprising:
a key display unit, configured to display at least one virtual key on display screen of the electronic device upon the electronic device connecting with a power source, wherein corresponding functions are pre-set to each of the at least one virtual key;
an operation identification unit, configured to generate operation command corresponding to a first virtual key of the at least one virtual key according to a user operation on the first virtual key, wherein the first virtual key is any one of the at least one virtual key; and
a control unit, configured to execute an operation corresponding to the corresponding function pre-set to the first virtual key in the electronic device according to the operation command.

7. The electronic device according to claim 6, wherein if the display screen is a touch screen, the operation identification unit is configured to:
obtain a touch signal generated by the display screen which is triggered by clicking the first virtual key by a user;
determine the virtual key selected by the user as the first virtual key according to the touch signal; and
generate the operation command corresponding to the first virtual key.

8. The electronic device according to claim 6, wherein if the display screen is a non-touch screen, the operation identification unit is configured to:
determine the virtual key selected by the user via somatosensory identification through a camera as the first virtual key when a user points to the first virtual key with a gesture; and
generate the operation command corresponding to the first virtual key; or receive a selection command generated by selecting the first virtual key by the user through a remote controller;
determine the virtual key selected by the user as the first virtual key according to the selection command; and
generate the operation command corresponding to the first virtual key.

9. The electronic device according to any one of claims 6-8, wherein the virtual keys comprise at least one of power key, home key, setting key, volume key and signal source key; the operation identification unit is configured to:
generate a command of starting up if the first virtual key is a power key;
generate a command of starting up and displaying the homepage if the first virtual key is a home key;
generate a command of starting up and displaying a setting page if the first virtual key is a setting key;
generate a command of adjusting volume if the first virtual key is a volume key;
generate a command of selecting signal source if the first virtual key is a signal source key.

10. The electronic device according to claim 9, wherein the control unit is configured to:
control the power source to supply power to the electronic device so that the electronic device starts up if the operating command is the command of starting up;
control the power source to supply power to the electronic device so that the electronic device starts up and displays the homepage on the display screen after starting up if the operating command is the command of starting up and displaying the homepage;
control the power source to supply power to the electronic device so that the electronic device starts up and displays the setting page on the display screen after starting up if the operating command is the command of starting up and displaying the setting page;
adjust volume output by the loudspeaker in the electronic device so that the electronic device outputs sound according to the adjusted output volume after starting up if the operating command is the command of adjusting volume;
select a signal source so that the electronic device obtains signals from the selected signal source after starting up if the operating command is the command of selecting signal source.
